(19) United States
(12) Patent Application Publication
(10) Pub. No.: US 2026/0120367 A1
(43) Pub. Date: Apr. 30, 2026

(54) GENERATING LABELED SYNTHETIC SEISMIC IMAGES

(71) Applicant: Schlumberger Technology Corporation, Sugar Land, TX (US)

(72) Inventors: Haibin Di, Houston, TX (US); Arvind Sharma, Houston, TX (US)

(21) Appl. No.: 19/374,454

(22) Filed: Oct. 30, 2025

Related U.S. Application Data
(60) Provisional application No. 63/714,309, filed on Oct. 31, 2024.

(51) Int. Cl. G06T 11/60; G01V 1/30; G01V 1/34; G06V 10/82; G06V 20/40

(52) U.S. Cl. CPC G06T 11/60; G01V 1/303; G01V 1/34; G06V 10/82; G06V 20/46; G01V 2210/74

(57) ABSTRACT

Certain aspects of the disclosure provide a method that comprises filtering a greyscale image with a seismic spectrum to produce an image footprint; grouping a masked image into object anomalies; smoothing the object anomalies to produce a synthetic geo-feature type image; imposing at least one of the image footprint or the synthetic geo-feature type image onto an initial velocity model to generate a final velocity model; and generating a synthetic seismic image from the final velocity model.

### CROSS-REFERENCE TO RELATED APPLICATIONS

This application claims the benefit of and priority to U.S. Provisional Patent Application No. 63/714,309, filed on Oct. 31, 2024, the entire contents of which are hereby incorporated by reference.

### BACKGROUND

### Field

Aspects of the present disclosure relate to generating labeled synthetic seismic images for training machine learning (ML) models.

### Description of Related Art

Certain ML models rely on training data to learn to recognize patterns, make predictions, or discriminate between different inputs. In some instances, the more diverse the data sets available to an ML model, the better the training outcomes and the results a trained ML model may produce. Diverse training data broadens the ML model's experience by increasing the ML model's exposure to different scenarios. Training data may be labeled or unlabeled. Labeled data comes with predefined labels or categories. Labeled data is generally used in supervised training, where each example training input has a known output. Unlabeled data may be used in unsupervised learning, where a model attempts to find patterns or distinguish between inputs without any guidance from labels. ML model training may also include validation and testing components to evaluate the performance of the ML model.

Artificial intelligence (AI) image recognition relies on image recognition ML models that aim to distinguish between large numbers of image types and image content with numerous variables. Image recognition ML models generally rely on large amounts of labeled training data in addition to significant computational power during training. Labeled training data refers to data (e.g., text or image data) that includes meaningful labels to teach an ML model. For example, a label may refer to a geographic location, a type of rock formation, or other information relevant about the data. Unlabeled data do not include meaningful labels. Once trained, image recognition ML models may identify and classify image content, such as objects, people, text and actions within images and videos. Typically, image recognition ML models rely on deep learning techniques to detect patterns and features in images. A common model architecture for such image recognition ML models is a convolutional neural network (CNN).

### SUMMARY

One aspect provides a method of generating labeled seismic images for training seismic image recognition ML models. The method includes filtering a greyscale image with a seismic spectrum to produce an image footprint; grouping contents of a masked image into object anomalies; smoothing the object anomalies to produce a synthetic geo-feature type image; imposing at least one of the image footprint or the synthetic geo-feature type image onto an initial velocity model to generate a final velocity model; and generating a synthetic seismic image from the final velocity model.

Other aspects provide processing systems configured to perform the aforementioned method as well as those described herein; non-transitory, computer-readable media including instructions that, when executed by a processors of a processing system, cause the processing system to perform the aforementioned methods as well as those described herein; a computer program product embodied on a computer readable storage medium including code for performing the aforementioned methods as well as those further described herein; and a processing system including means for performing the aforementioned methods as well as those further described herein.

Yet another aspect provides a non-transitory computer-readable medium including instructions that, when executed by one or more processors of a computing system, cause the computing system to perform operations including filtering a greyscale image with a seismic spectrum to produce an image footprint; grouping a masked image into object anomalies; smoothing the object anomalies to produce a synthetic geo-feature type image; imposing at least one of the image footprint or the synthetic geo-feature type image onto an initial velocity model to generate a final velocity model; and generating a synthetic seismic image from the final velocity model.

The following description and the related drawings set forth in detail certain illustrative features of one or more aspects.

### DESCRIPTION OF THE DRAWINGS

The appended figures depict certain aspects and are therefore not to be considered limiting the scope of this disclosure.

FIG. 1 depicts a process for generating labeled synthetic seismic images from labeled data files.

FIG. 2 depicts examples of images involved in the proposed labeled synthetic seismic image generation process of FIG. 1.

FIG. 3 depicts an example method of labeled synthetic seismic image generation.

FIG. 4 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating labeled synthetic seismic images for training ML models. Seismic images may refer to images of the earth's surface or subsurface and may include geological structures or artifacts. Synthetic seismic images as described herein refer to images generated by the proposed synthetic seismic image generation process described by the present disclosure, instead of seismic images created by conventional techniques.

Similar to other image recognition ML models, seismic image recognition ML models (e.g., ML models designed and trained to recognize or classify seismic images and their content) rely on labeled images (e.g., labeled seismic images) for training purposes. A seismic image recognition ML model may be designed to recognize geological features and layers of the Earth's subsurface from seismic images. Seismic images often use the seismic spectrum (also referred to as the response spectrum) to provide imaging of a subsurface. Unlike natural photos, seismic images are usually single channel (e.g., unlike natural images that use the RGB channel of Red-Green-Blue). Generally, seismic images are bandlimited to between 20-80 Hz. For example, seismic waves (e.g., in the form of vibrations or soundwaves) may be used to generate a cross-sectional graphical view of the Earth's subsurface to generate seismic images. For example, seismic images may be created by capturing data of soundwave travel within the Earth's subsurface and processing the captured data to create a seismic image. The seismic spectrum refers to a range of ground motion frequencies representing a distribution of energy within ground motion as a function of frequency. The seismic spectrum may include a response spectrum which displays a maximum response of a system to ground motion at different frequencies or may include a Fourier amplitude spectrum that shows distribution of energy within ground motion as a function of frequency. The seismic spectrum denotes the spectrum of a seismic signal, which usually is bandlimited between 20-80 Hz with a peak at around 40-60 Hz.

While there is a plethora of seismic images available publicly, only a limited number of these seismic images are labeled images that may be used for training seismic image recognition ML models. Labels for seismic images may be labeled in various ways depending on the training objective. For example, the labels may be annotations related to coordinates or location information for training a seismic image recognition model designed to identify a location from a seismic image. An extant technical problem in the art is the lack of available, high-quality labeled training data to train seismic image recognition ML models.

Moreover, other image recognition models, such as natural image recognition ML models, trained on large datasets of labeled images, are not suited for recognizing or classifying seismic images. This is because natural image recognition ML models are trained on natural images. Natural images differ from seismic images in their spectrum bandwidth, the objects present, noise profiles, and the like. Therefore, open-source natural image/video datasets are not well suited for training seismic image recognition ML models.

Aspects described herein present systems, apparatuses, and methods for generating labeled synthetic seismic images from natural images and video data sets (e.g., from open-source image/video data sets). The labeled synthetic seismic images may be two-dimensional or three-dimensional. The labeled synthetic seismic images simulate typical seismic signatures and presents natural objects as geo-features. Geo-features may be found in ordinary seismic images and therefore are suited for training seismic image recognition ML models. Geo-features may include geological-anomalies or geological-bodies. The described techniques for the generation of high-quality labeled seismic images for the training of seismic image recognition ML models from publicly available labeled general images provide a technical solution to the aforementioned technical problem of unavailability of high quality labeled seismic image data.

In some aspects, the techniques may include transformation of labeled images or videos into velocity models, which are then run in simulation(s) to generate labeled synthetic seismic images. The techniques provide several technical benefits.

One such technical benefit is the ability to efficiently generate large labeled synthetic seismic image data sets from smaller data sets, which reduces the need for storage in databases and server systems, since large data sets may be generated from a small image source database when desired.

A second technical benefit, is improved training of seismic image recognition ML models based on the use of large datasets of high-quality labeled synthetic seismic images, resulting in higher performing seismic image recognition ML models able to more accurately classify and recognize seismic images.

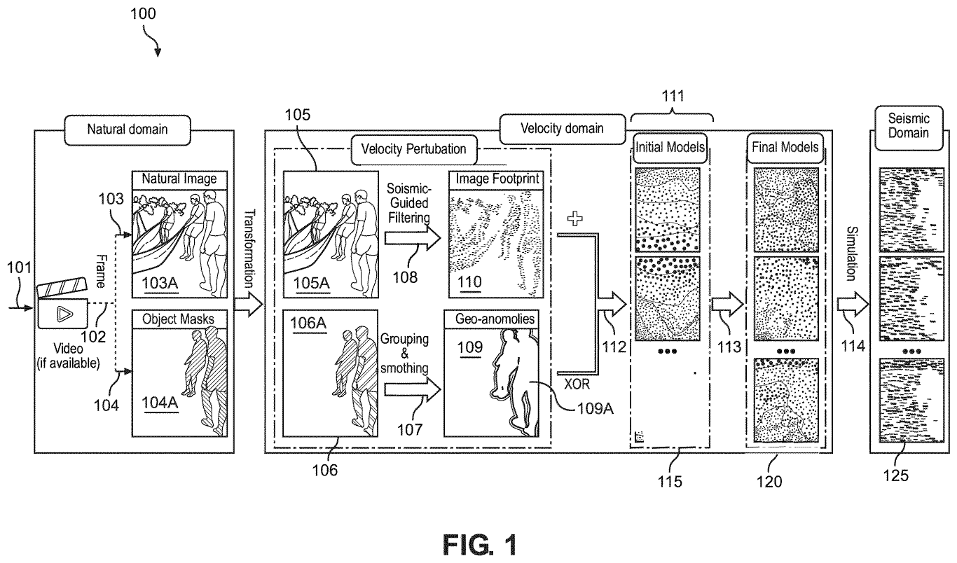

FIG. 1 depicts a process 100 for generating labeled synthetic seismic images from labeled images.

The process 100 includes using a labeled image pair derived from a source image with label(s) to generate labeled synthetic seismic image(s). The labeled image pair may be pre-processed and then imposed onto velocity model(s). The velocity model(s) may then be used in one or more simulations to generate the synthetic seismic image(s). The label of the source image is carried over to the labeled synthetic seismic image(s) that is generated. A velocity model represents the variation of velocity in which seismic wave propagates along a depth of the Earth (referred to herein simply as velocity). In certain aspects the velocity of the seismic wave increases as it travels from shallower to deeper depths. Generating the synthetic seismic image(s) with label(s) of an original source image increases the total training data available, as well as the diversity of available training data to train seismic image recognition ML models, which allows them to be trained on a wide range of labeled synthetic seismic image(s) improving their accuracy in recognizing and classifying various types of seismic data. The labeled synthetic seismic image(s) generated include data-label pairs from the original source image that are carried over and may be used to build seismic models.

The process 100 begins by obtaining a labeled data file 101A at step 101 (e.g., by an apparatus such a computing device). The labeled data file 101A may include, for example, a source image or source video file having annotation(s) or label(s). For example, the source image may include frame(s) from the labeled data file 101A. In some aspects, the apparatus may obtain the data file from an open data source. An open data source is a collection of data made freely available to the public without restrictions on its use. One example is the segment anything open-source database. The obtaining of the labeled data file 101A at step 101 may include receiving push data or pulling the labeled data file from an open-source data set.

In some aspects, the process 100 includes obtaining the labeled data file 101A and splitting the labeled data file 101A into one or more frames or images.

At step 102, process 100 extracts an image pair 102A from the labeled data file 101A. An image pair as referred to herein may describe two related images that are used together for comparison, analysis, or processing, or any other step described in relation to the process 100. The image pair may be derived from a single source, such as the labeled data file 101A, or an individual frame of the labeled data file 101A. Moreover, the images in the image pair 102A may be used in similar or dissimilar ways (e.g., in the same processes or separate distinct processes). For example, the extracting of the image pair 102A at step 102 may involve, for example, duplicating the labeled data file 101A into two identical images, or extracting an image from a frame of a labeled video or other image file and duplicating the extracted image into the image pair 102A. In some aspects, the image pair 102A includes a first image and a second image.

At step 103, the process 100 may select a first image from the image pair that is a natural image 103A. A natural image may refer to a raw image, a captured image, or an image frame that has not been altered or edited.

In aspects, the process 100 at step 104 may generate a masked image 104A from the second image of the image pair (e.g., the image that was not selected at step 103). For example, generating the masked image 104A at step 104 may include making a determination of masks present in the second image in its natural state (e.g., prior to alterations or masking), ranking the present masks based on one or more pre-defined criteria (e.g., mask size), selecting one or more masks from the masks present in the second image, and applying the selected mask(s) to the second image (e.g., object masking) to generate the masked image 104A. In some aspects, the masks or number of masks may be randomly selected and applied on the second image at step 104. A random mask may be selected to generate randomized diverse geo-feature type images training data. In some aspects, the steps 103 and 104 occur concurrently. In aspects, the masked image 104A is then used to generate a geo-feature type image to model geo-features in seismic images that a seismic image recognition ML model is trained on as described in further detail below.

At step 105, the process 100 transforms the natural image 103A to a greyscale image 105A. The transforming of the natural image 103A into the greyscale image 105A removes large portions of the color spectrum, simplifying the natural image 103A and preparing it to be filtered by seismic filter(s) to be transformed into a seismic image.

At step 106, process 100 may group objects together in the masked image 104A. The objects grouped together may be, for example, foreground or background objects. Grouping objects together may reduce the number of classes in the masked image 104A to generate a grouped masked image 106A. A class in an image may refer to known objects, colors or patterns. For example, the number of colors are reduced by grouping several objects together into one object by applying one pattern or color. The grouped masked image 106A is a simplified image of the masked image 104A, and is closer in its properties to a geo-feature type image rather than a natural image. Grouping may involve applying a uniform class to the various objects.

At step 107, the process 100 applies smoothing to the grouped objects in the grouped masked image 106A, which may beneficially reduce the number of distinct objects in the grouped masked image 106A and reduce sharpness of boundaries between the distinct objects. The resulting smoothed image may simulate a geo-feature type image (referred to herein as synthetic geo-feature type image 109) having one or more anomalies 109A that seismic image recognition ML models can be trained on. The grouped masked image 106A may originally be of any natural object, but when smoothing or grouping of objects is combined with masking of the objects, then the objects in the image become similar to geo-features present in geo-feature type images, allowing a seismic image recognition ML model to be trained on the resulting synthetic geo-feature type image 109.

At step 108, the process 100 filters the greyscale image with a seismic spectrum to produce an image footprint 110 having a seismic spectrum. The image footprint 110 may represent an image signature of the greyscale image that is a combination of various characteristics of the greyscale image including and not limited to, bit depth, brightness, contrast, dynamic range, noise, sharpness, or texture. Seismic images generally do not contain the background of natural images, such as that of the natural image obtained at 103. Therefore, to generate a seismic image, the natural image (after being greyscale) may be filtered using the seismic spectrum to remove the background features that do not conform to a seismic image to generate the image footprint at 108. The filtering at 108 may include calculating a spectrum of the greyscale image and multiplying it with a common seismic spectrum (e.g., an average of various seismic spectrums) in a spectrum domain and then converting the product back to an image domain. While the image footprint generated at step 108 may still contain simulated geo-features, it also will contain low frequency information to perturb the velocity models (e.g., adding the image footprint to the velocity models adds the low frequency information to the velocity models).

At step 111, the process 100 may select initial velocity model(s) 115 (alternatively referred to as velocity perturbation(s)). At step 111, the initial velocity model(s) 115 may be selected from a velocity model library. A velocity model library may be a publicly available open-source library. In some aspects, at step 111 the process 100 may receive initial velocity model(s) 115 that are pre-selected. In aspects, the initial velocity model(s) 115 are basin dependent, for example, a velocity model associated with Australia is different from one associated with the North Sea. By specifying information (e.g., based on location data) suitable initial velocity model(s) 115 may be selected or received at step 111, so that the generated seismic image(s) are more relevant to the geology. The initial velocity model(s) 115 may reflect geological features from shallow to deep areas (e.g., areas of low velocity to high velocity) of the Earth's subsurface. At step 111, the process may include selecting or receiving multiple initial velocity model(s) 115 to generate multiple labeled synthetic seismic images simultaneously (e.g., each initial velocity model 115 generates a number of synthetic seismic image 125). Velocity models may differ based on data from the different geographical areas they are based on, therefore selecting multiple velocity models helps increase the diversity of outputs generated at step 113. The initial velocity model(s) 115 selected may include geo-anomalies and may be selected based on these geo-anomalies. A geo-anomaly may refer to a geological or geospatial phenomenon that deviates from normal geo-features of a geological setting or environment (e.g., what is typically observed in such environments). A geo-anomaly may indicate deviations in the underlying rock composition, geophysical field from what is typical and may be related to a geological event.

At step 112, the process 100 imposes one or both of the image footprint 110 and the synthetic geo-feature type image 109 onto the initial velocity model(s) 115 to adjust or perturb the initial velocity model(s) 115. In some aspects, the initial velocity model(s) 115 are large scale models without any geo-anomalies, and the imposition of the image footprint 110 or the synthetic geo-feature type image 109 onto the initial velocity model(s) 115 at step 112 increases the complexities of the initial velocity model(s) 115 by adding the synthetic geo-features of the synthetic geo-feature type image 109 to the initial velocity model(s) 115. The final velocity model(s) 120 may be a combination of one or more of the image footprint 110, the initial velocity model(s) 115 and the synthetic geo-feature type image 109, to generate the final velocity model(s) 120, which more closely simulate seismic image(s) (e.g., by having synthetic geo-features of a seismic image), and are suitable for generating the synthetic seismic image 125.

In aspects, at step 112, only the image footprint 110 is imposed onto the initial velocity model(s) 115, while the synthetic geo-feature type image 109 is not be imposed on the initial velocity model(s) 115 (e.g., or is only imposed as a parameter). In some aspects, the synthetic geo-feature type image 109 may be imposed at step 112 at different levels. For example, the synthetic geo-feature type image 109 as a whole may be imposed as different values onto the velocity model(s) 115. For example, each object in the image is treated separately (e.g., a human object and a car object) as a set of different geo-features. Therefore, these distinct sets of geo-features may be aggregated in generating a final velocity model.

Or for example, different geo-features within the synthetic geo-feature type image 109 may each be imposed as different values onto the velocity model(s) 115. In aspects, the synthetic geo-feature type image 109 may be fully imposed onto the initial velocity model(s) 115, and the velocity within geo-features introduced into the velocity model(s) will be constant. For example, the operation combines the geo-feature type image 109 and the initial velocity model(s) 115 by addition. However, if the synthetic geo-feature type image 109 is not imposed at all (e.g., where geo-feature values added equal zero), the velocity of the initial velocity model(s) 115 will be unaffected. Therefore, the magnitude of values associated with the imposed synthetic geo-feature type-images 109 affect the extent that the synthetic geo-feature(s) in the synthetic geo-feature type-image 109 impact the initial velocity model(s) 115 to generate the final velocity model(s) 120. For example, at step 112, the process 100 may forego imposing the synthetic geo-feature type image 109 onto the initial velocity model(s) 115 to reduce the presence of synthetic geo-features in the final generated labeled synthetic seismic image 125.

At step 113, the process 100 includes generating the final velocity model(s) 120 based on the output of step 112. In other words, the initial velocity model(s) 115 are adjusted by the image footprint 110 and/or the synthetic geo-features of the synthetic geo-feature type image 109 to generate the final velocity model(s) 120. In some aspects, each final velocity model 120 corresponds with one initial velocity model 115, while in others, one initial velocity model 115 may generate multiple final velocity models 120.

At step 114, the process 100 provides the final velocity model(s) 120 as input into one or more simulations, such as a simulation having a deterministic algorithm, a stochastic algorithm, or an ML model, to generate a synthetic seismic image 125 based on the final velocity model(s) 120. The label(s) of the labeled data file 101A (e.g., the labeled video or image) obtained at step 101 carry through to the synthetic seismic image 125 generated at step 114. The one or more simulations may be performed by one or more potential algorithms for generating the synthetic seismic image 125 at step 114. For example, a simple algorithm includes the “1D” algorithm that convolves a wavelet with vertical changes in acoustic impedance (e.g., changes in velocity). These vertical changes may be calculated by multiplying a velocity with the density of rocks. In aspects, more complicated algorithms may use wave-propagation equations or ML models.

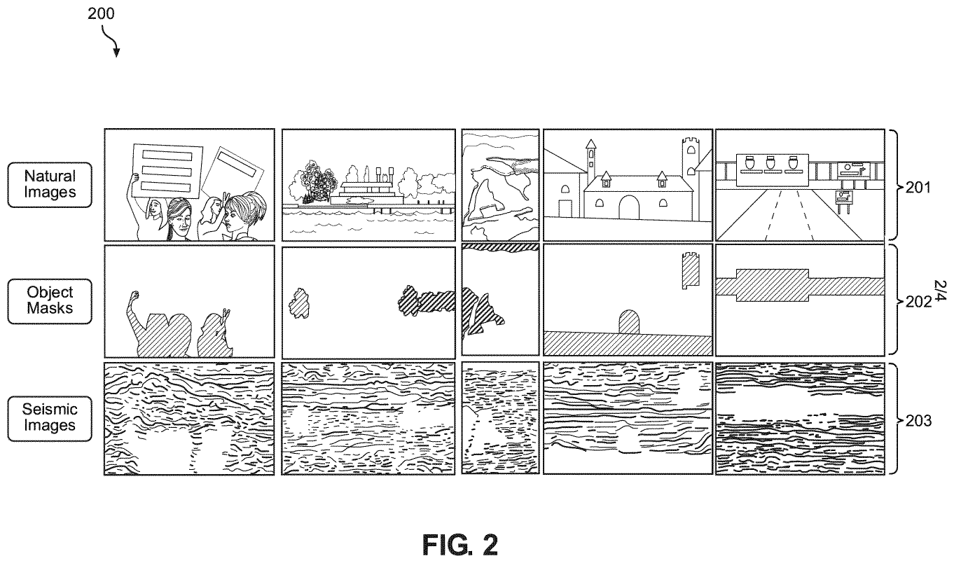

FIG. 2 depicts examples of images involved in the proposed generation process described herein.

The example images 200 include a set of natural images 201, which may correspond to the natural image selected at step 103 of FIG. 1. The natural images of the set of natural images 201 may be associated with various domains based on the objects in the images, such as people, natural environments, man-made structures, transportation routes, aerial imagery, and the like. The diversity of domain types in the set of natural images at 201 improves the diversity of the labeled synthetic seismic images generated, which in turn improves the training outcomes for seismic image recognition ML models.

The example images 200 also include a set of masked images 202 generated from the set of natural images 201. Image(s) of the set of masked images 202 may correspond to the natural image 103A selected at step 103 of FIG. 1.

The example images 200 further include a set of seismic images 203 generated from the set of natural images 201 and/or the masked images 202. Images of the set of seismic images 203 may correspond to the synthetic seismic image 125 generated at step 114 of FIG. 1.

### Example Operations

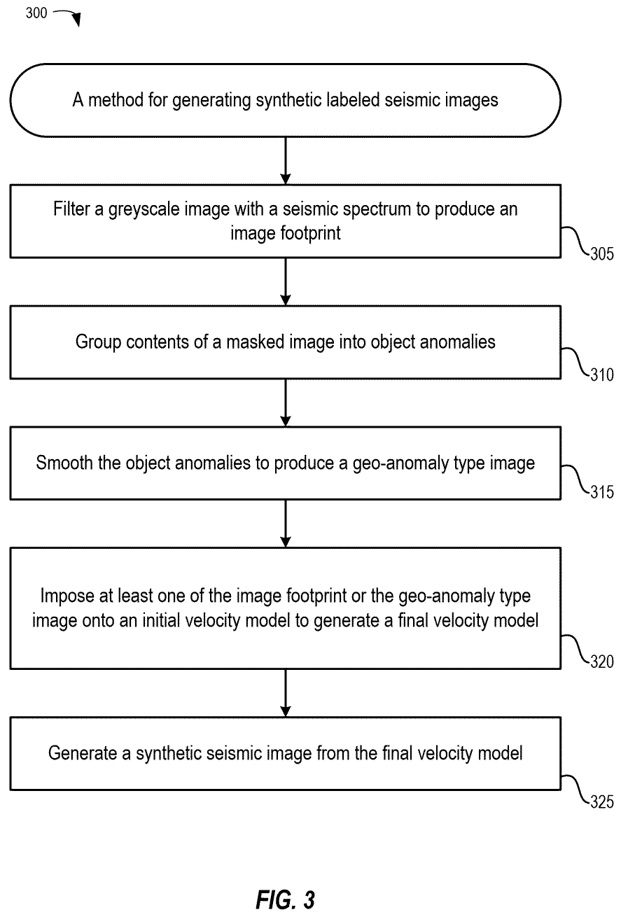

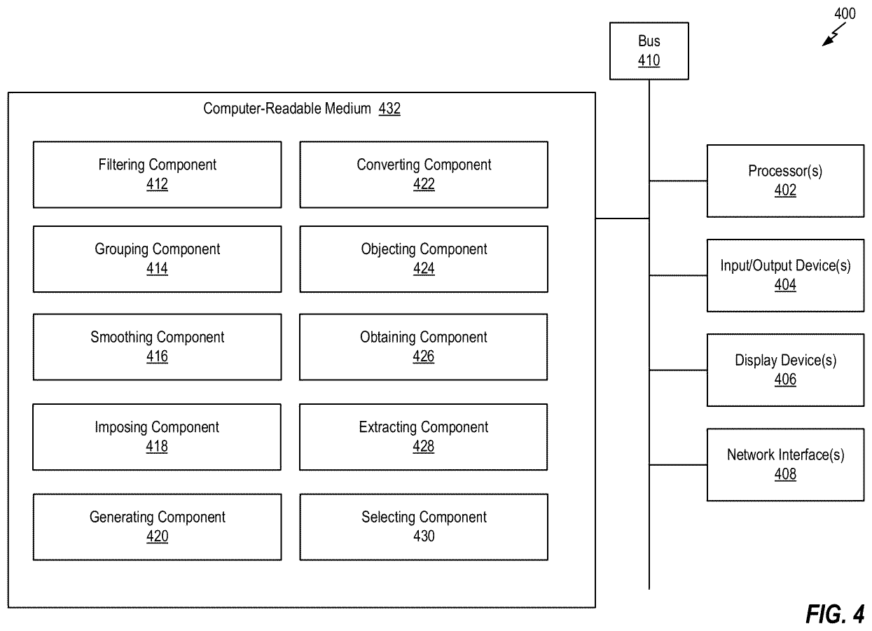

FIG. 3 shows an example method 300. In one aspect, method 300, or any aspect related to it, may be performed by an apparatus or a processing system, such as processing system 400 of FIG. 4, which includes various components operable, configured, or adapted to perform the method 300. Processing system 400 is described below in further detail.

The method 300 begins at block 305 with filtering a greyscale image (e.g., the greyscale image 105A of FIG. 1) with a seismic spectrum to produce an image footprint (e.g., the image footprint 110 of FIG. 1). The block 305 may correspond to step 108 of FIG. 1.

The method 300 then proceeds to block 310 with grouping contents of a masked image (e.g., the masked image 104A of FIG. 1) into object anomalies (e.g., the object anomalies 109A of FIG. 1). The block 310 may correspond to step 106 of FIG. 1.

The method 300 then proceeds to block 315 with smoothing the object anomalies to produce a synthetic geo-feature type image (e.g., synthetic geo-feature type image 109 of FIG. 1). The block 315 may correspond to step 107 of FIG. 1.

The method 300 then proceeds to block 320 with imposing at least one of the image footprint or the synthetic geo-feature type image onto an initial velocity model (e.g., the initial velocity model(s) 115 of FIG. 1) to generate a final velocity model (e.g., the final velocity model(s) 120 of FIG. 1). The block 320 may correspond to step 112 of FIG. 1.

The method 300 then proceeds to block 325 with generating a synthetic seismic image (e.g., the synthetic seismic image 125) from the final velocity model. The block 320 may correspond to step 114 of FIG. 1.

In aspects, the method 300 further includes converting a first image of an image pair into the greyscale image.

In aspects, the method 300 further includes object masking a second image of an image pair to generate the masked image.

In aspects, the method 300 further includes obtaining a labeled image (e.g., the labeled data file 101A of FIG. 1) from an open-source image dataset.

In aspects, the method 300 further includes extracting an image pair from the labeled image.

In aspects, the block 325 includes generating the synthetic seismic image using at least one of a deterministic algorithm, stochastic algorithm, or a machine learning model.

In aspects, the ML model is a CNN.

In aspects, the method 300 further includes selecting the initial velocity model from a velocity model library. A velocity model library may be an open-source library or database containing one or more velocity models.

In aspects, the synthetic seismic image comprises a label. A label may include a meaningful label or annotation added to the image or carried over from the original labeled image. A label may include metadata or other information associated with a data file or its contents.

In aspects, the method 300 further includes obtaining a labeled video from an open-source dataset. In aspects the labeled video corresponds to the labeled data file 101A.

In aspects, the method 300 further includes extracting an image pair from a frame of the labeled video.

In aspects, the method 300 includes adding the synthetic seismic image to a training dataset, wherein the synthetic seismic image is associated with labels; and training a seismic image recognition ML model on the training dataset to recognize geo-features in the synthetic seismic image based on the labels. For example, the labels may guide the target outputs of the training.

Note that FIG. 3 is just one example of a method, and other methods including fewer, additional, or alternative operations are possible consistent with this disclosure.

### Example Processing System for Generating Labeled Seismic Images for Training ML Models

FIG. 4 depicts an example processing system 400 configured to perform various aspects described herein, including, for example, method 300 as described above with respect to FIG. 3.

Processing system 400 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 400 includes one or more processor(s) 402, one or more input/output device(s) 404, one or more display device(s) 406, one or more network interface(s) 408 through which processing system 400 is connected to one or more networks (e.g., a local network, an intranet, the Internet, or any other group of processing systems communicatively connected to each other), and computer-readable medium 432. In the depicted example, the aforementioned components are coupled by a bus 410, which may generally be configured for data exchange amongst the components. Bus 410 may be representative of multiple buses, while only one is depicted for simplicity.

Processor(s) 402 are generally configured to retrieve and execute instructions stored in one or more memories, including local memories like computer-readable medium 432, as well as remote memories and data stores. Similarly, processor(s) 402 are configured to store application data residing in local memories like the computer-readable medium 432, as well as remote memories and data stores. More generally, bus 410 is configured to transmit programming instructions and application data among the processor(s) 402, display device(s) 406, network interface(s) 408, and/or computer-readable medium 432. In certain embodiments, processor(s) 402 are representative of a one or more central processing units (CPUs), graphics processing unit (GPUs), tensor processing unit (TPUs), accelerators, and other processing devices.

Input/output device(s) 404 may include any device, mechanism, system, interactive display, and/or various other hardware and software components for communicating information between processing system 400 and a user of processing system 400. For example, input/output device(s) 404 may include input hardware, such as a keyboard, touch screen, button, microphone, speaker, and/or other device for receiving inputs from the user and sending outputs to the user.

Display device(s) 406 may generally include any sort of device configured to display data, information, graphics, user interface elements, and the like to a user. For example, display device(s) 406 may include internal and external displays such as an internal display of a tablet computer or an external display for a server computer or a projector. Display device(s) 406 may further include displays for devices, such as augmented, virtual, and/or extended reality devices. In various embodiments, display device(s) 406 may be configured to display a graphical user interface.

Network interface(s) 408 provide the processing system 400 with access to external networks and thereby to external processing systems. Network interface(s) 408 can generally be any hardware and/or software capable of transmitting and/or receiving data via a wired or wireless network connection. Accordingly, network interface(s) 408 can include a communication transceiver for sending and/or receiving any wired and/or wireless communication.

Computer-readable medium 432 may be a volatile memory, such as a random-access memory (RAM), or a nonvolatile memory, such as nonvolatile random-access memory (NVRAM), or the like. In this example, computer-readable medium 432 includes filtering component 412, grouping component 414, smoothing component 416, imposing component 418, generating component 420, converting component 422, objecting component 424, obtaining component 426, extracting component 428, and selecting component 430.

In certain embodiments, filtering component 412 is configured to filter a greyscale image with a seismic spectrum to produce an image footprint. For example, this may correspond to step 105 of process 100 of FIG. 1 to transform the natural image to a greyscale image. In aspects, this may correspond to filtering a greyscale image with a seismic spectrum to produce an image footprint at block 305 of FIG. 3.

In certain embodiments, grouping component 414 is configured to group contents of a masked image into object anomalies. For example, this may correspond to step 106 of process 100 of FIG. 1, to optionally group objects together. In aspects, this may correspond to grouping contents of a masked image into object anomalies of block 310 of FIG. 3.

In certain embodiments, smoothing component 416 is configured to smooth the object anomalies to produce a synthetic geo-feature type image. For example, this may correspond to step 107 of process 100 of FIG. 1, to smooths the grouped objects in the masked image. In aspects, this may correspond to smoothing the object anomalies to produce a synthetic geo-feature type image at block 315 of FIG. 3.

In certain embodiments, imposing component 418 is configured to impose at least one of the image footprint or the synthetic geo-feature type image onto an initial velocity model to generate a final velocity model. For example, this may correspond to step 112 of process 100 of FIG. 1 to impose one or both of the image footprint and the synthetic geo-feature type image onto the initial velocity model(s). In aspects, this may correspond to imposing at least one of the image footprint or the synthetic geo-feature type image onto an initial velocity model to generate a final velocity model at block 320 of FIG. 3.

In certain embodiments, generating component 420 is configured to generate a synthetic seismic image from the final velocity model. For example, this may correspond to step 114 of process 100 of FIG. 1, to provide the final velocity model(s) as input into one or more simulations to generate the synthetic seismic image. In aspects, this may correspond to generating a synthetic seismic image from the final velocity model at 325 of FIG. 3.

Note that FIG. 4 is just one example of a processing system consistent with aspects described herein, and other processing systems having additional, alternative, or fewer components are possible consistent with this disclosure.

### Example Clauses

Implementation examples are described in the following numbered clauses:

Clause 1: A method including filtering a greyscale image with a seismic spectrum to produce an image footprint; grouping contents of a masked image into object anomalies; smoothing the object anomalies to produce a synthetic geo-feature type image; imposing at least one of the image footprint or the synthetic geo-feature type image onto an initial velocity model to generate a final velocity model; and generating a synthetic seismic image from the final velocity model.

Clause 2: The method of Clause 1, further including converting a first image of an image pair into the greyscale image.

Clause 3: The method of any one of Clauses 1-2, further including object masking a second image of an image pair to generate the masked image.

Clause 4: The method of any one of Clauses 1-3, further including obtaining a labeled image from an open-source image dataset; and extracting an image pair from the labeled image.

Clause 5: The method of any one of Clauses 1-4, wherein generating a synthetic seismic image comprises generating the synthetic seismic image using at least one of a deterministic algorithm, stochastic algorithm, or a machine learning model.

Clause 6: The method of Clause 5, wherein the machine learning model is a CNN.

Clause 7: The method of any one of Clauses 1-6, further including selecting the initial velocity model from a velocity model library.

Clause 8: The method of any one of Clauses 1-7, wherein the synthetic seismic image includes a label.

Clause 9: The method of any one of Clauses 1-8, further including obtaining a labeled video from an open-source dataset; and extracting an image pair from a frame of the labeled video.

Clause 10: The method of any one of Clauses 1-9, further including adding the synthetic seismic image to a training dataset, wherein the synthetic seismic image is associated with labels; and training a seismic image recognition ML model on the training dataset to recognize geo-features in the synthetic seismic image based on the labels.

Clause 11: One or more processing systems, including one or more memories including computer-executable instructions; and one or more processors configured to execute the computer-executable instructions and cause the one or more processing systems to perform a method in accordance with any one of Clauses 1-10.

Clause 12: One or more processing systems, including means for performing a method in accordance with any one of Clauses 1-10.

Clause 13: One or more non-transitory computer-readable media including instructions that, when executed by one or more processors of a computing system, cause the computing system to perform the operations of any one of Clauses 1-10.

Clause 14: One or more computer program products embodied on one or more computer-readable storage media including code for performing a method in accordance with any one of Clauses 1-10.

### Additional Considerations

The preceding description is provided to enable any person skilled in the art to practice the various embodiments described herein. The examples discussed herein are not limiting the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method that is practiced using other structure, functionality, structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, unless stated otherwise, the term “or” is used in an inclusive sense. This inclusive usage of or is equivalent to “and/or”. Thus, when options are delineated using “or,” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
filtering a greyscale image with a seismic spectrum to produce an image footprint;
grouping a masked image into object anomalies;
smoothing the object anomalies to produce a synthetic geo-feature type image;
imposing at least one of the image footprint or the synthetic geo-feature type image onto an initial velocity model to generate a final velocity model; and
generating a synthetic seismic image from the final velocity model.

2. The method of claim 1, further comprising converting a first image of an image pair into a greyscale image.

3. The method of claim 1, further comprising object masking a second image of an image pair to generate a masked image.

4. The method of claim 1, further comprising:
obtaining a labeled image from an open-source image dataset; and
extracting an image pair from the labeled image.

5. The method of claim 1, wherein the generating of the synthetic seismic image comprises using at least one of a deterministic algorithm, stochastic algorithm, or a machine learning model.

6. The method of claim 5, wherein the machine learning model is a convolutional neural network (CNN).

7. The method of claim 1, further comprising selecting the initial velocity model from a velocity model library.

8. The method of claim 1, wherein the synthetic seismic image comprises a label.

9. The method of claim 1, further comprising:
obtaining a labeled video from an open-source dataset; and
extracting an image pair from the labeled video.

10. A processing system, comprising:
one or more memories comprising computer-executable instructions; and
one or more processors configured to execute the computer-executable instructions and cause the processing system to:
filter a greyscale image with a seismic spectrum to produce an image footprint;
group a masked image into object anomalies;
smooth the object anomalies to produce a synthetic geo-feature type image;
impose at least one of the image footprint or the synthetic geo-feature type image onto an initial velocity model to generate a final velocity model; and
generate a synthetic seismic image from the final velocity model.

11. The processing system of claim 10, wherein the one or more processors are further configured to execute the computer-executable instructions and cause the processing system to convert a first image of an image pair into a greyscale image.

12. The processing system of claim 10, wherein the one or more processors are further configured to execute the computer-executable instructions and cause the processing system to object mask a second image of an image pair to generate a masked image.

13. The processing system of claim 10, wherein the one or more processors are further configured to execute the computer-executable instructions and cause the processing system to:
obtain a labeled image from an open-source image dataset; and
extract an image pair from the labeled image.

14. The processing system of claim 10, wherein the generating of the synthetic seismic image comprises using at least one of a deterministic algorithm, stochastic algorithm, or a machine learning model.

15. The processing system of claim 14, wherein the machine learning model is a convolutional neural network (CNN).

16. The processing system of claim 10, wherein the one or more processors are further configured to execute the computer-executable instructions and cause the processing system to select the initial velocity model from a velocity model library.

17. The processing system of claim 10, wherein the synthetic seismic image comprises a label.

18. The processing system of claim 10, wherein the one or more processors are further configured to execute the computer-executable instructions and cause the processing system to:
obtain a labeled video from an open-source dataset; and
extract an image pair from the labeled video.

19. A non-transitory computer-readable medium comprising instructions that, when executed by one or more processors of a computing system, cause the computing system to perform operations comprising:
filtering a greyscale image with a seismic spectrum to produce an image footprint;
grouping a masked image into object anomalies;
smoothing the object anomalies to produce a synthetic geo-feature type image;
imposing at least one of the image footprint or the synthetic geo-feature type image onto an initial velocity model to generate a final velocity model; and
generating a synthetic seismic image from the final velocity model.

20. The non-transitory computer-readable medium of claim 19, wherein the instructions when executed cause the computing system to perform further operations comprising:
adding the synthetic seismic image to a training dataset, wherein the synthetic seismic image is associated with labels; and
training a seismic image recognition ML model on the training dataset to recognize geo-features in the synthetic seismic image based on the labels.
